(19) United States
(12) Patent Application Publication
(10) Pub. No.: US 2025/0180525 A1
(43) Pub. Date: Jun. 5, 2025

(54) SHORT COLUMNS CONNECTED IN SERIES FOR BIOSEPARATIONS

(71) Applicant: Waters Technologies Corporation, Milford, MA (US)

(72) Inventors: Wade P. Leveille, Douglas, MA (US); Fabrice Gritti, Franklin, MA (US); Jason F. Hill, Upton, MA (US); Sornanathan Meyyappan, Framingham, MA (US)

(21) Appl. No.: 18/967,947

(22) Filed: Dec. 4, 2024

Related U.S. Application Data
(60) Provisional application No. 63/606,317, filed on Dec. 5, 2023.

(51) Int. Cl. G01N 30/60; G01N 30/46

(52) U.S. Cl. CPC G01N 30/6039; G01N 30/465; G01N 30/6017; G01N 30/6026; G01N 30/603; G01N 2030/6013

(57) ABSTRACT

A chromatography column assembly includes a standard column length of at least 100 mm and a plurality of columns connected in series. Each of the plurality of columns add up in length to the standard column length. Further disclosed are liquid chromatography systems including the described chromatography assemblies, and chromatographic methods deploying the described chromatographic assemblies.

### PRIORITY

This application claims priority to U.S. provisional patent application No. 63/606,317 filed Dec. 5, 2024 and titled “Short Columns Connected in Series for Bioseparations,” the entirety of which is incorporated by reference herein.

### FIELD OF THE INVENTION

The disclosed technology generally relates to chromatography columns. More particularly, the technology relates to a chromatography column assembly which possesses desirable axial dispersion characteristics.

### BACKGROUND

In typical chromatographic columns, a mobile phase and injected sample are introduced to a column separation bed through a fluidic conduit coupled to an end nut at the column inlet. The mobile phase then flows through some form of distributor coupled to a frit so that the mobile phase is distributed substantially uniformly over the inlet surface of the column separation bed.

Particulate chromatography columns for high performance liquid chromatography (HPLC) and ultra-performance liquid chromatography (UPLC) are typically packed with particles having a particle size in a range of about 1.6 μm to 5.0 μm. The particles are packed under high pressure, for example, from about 70 MPa (10,000 psi) to about 200 MPa (30,000 psi) using conventional slurry packing protocols. During the particle bed consolidation, a higher stress occurs in particles located near the stainless-steel wall (e.g., within a region approximately 150 μm from the wall) relative to the stress that occurs for particles in the center bulk region of the column.

The wall-to-center stress profile due to packing results in a wall-to-center bed heterogeneity defined by local interparticle void fraction. Consequently, the linear chromatographic velocity for the region of particles near the wall is less than for the region near the center of the column. This radial variation in linear chromatographic velocity (i.e., the “wall effect”) distorts the chromatographic band. As a result, a detected chromatographic band corresponding to an analyte in the injected sample may exhibit peak tailing where the peak width is broader than otherwise expected. Thus, the resolution power is degraded. This effect is particularly problematic for certain applications such as Monoclonal Antibodies (mAb) applications.

The complete baseline separation of mAbs from aggregates, sub-units, and from other culture impurities may not be fully successful with a single 2.1 mm inner diameter and 300 mm long size exclusion chromatography (SEC) column packed with sub-2.0 μm fully porous particles. 4.6 mm inner diameter columns may provide better separations but the advantage of 2.1 mm inner diameter versus 4.6 mm inner diameter columns is a four times reduction in mobile phase consumption and the adoption by the users of more compact chromatography systems.

This problem is related to the non-uniform structure of the packed bed across long 2.1 mm inner diameter columns. As a result, 2.1 mm inner diameter and 300 mm long SEC columns perform under sub-optimal dispersion conditions for two combined reasons. First, the radial flow heterogeneity increases axial dispersion along these columns. Second, the separation is in practice operated in a dispersion too close to the asymptotic dispersion regime characterized by the highest axial dispersion coefficient along the column.

Thus, a chromatography column assembly which possesses desirable axial dispersion characteristics which would be applicable to mAb separations would be well received in the art.

### SUMMARY

In one aspect, a chromatography column assembly comprises: a standard column length of at least 100 mm; and a plurality of columns connected in series, where each of the plurality of columns add up in length to the standard column length.

In another aspect, a liquid chromatography system comprises: a solvent delivery system configured to provide a flow of a mobile phase; a sample delivery system configured to inject a volume of a sample into the mobile phase; and chromatography column assembly that includes a standard column length of at least 100 mm and a plurality of columns connected in series, where each of the plurality of columns add up in length to the standard column length. The chromatography column assembly is located downstream from the sample delivery system and the solvent delivery system. The liquid chromatography system further includes a detector located downstream from the chromatography column assembly.

In another aspect, a chromatographic method comprises: determining a chromatographic length for a separation process; dividing the chromatographic length into a plurality of sub-parts; assembling a chromatography column assembly that includes a plurality of columns connected in series, wherein each of the plurality of columns extends across one of the plurality of sub-parts such that the plurality of columns together equal the chromatographic length; performing a separation process such that a sample sequentially moves through each of the plurality of columns connected in series; and detecting the sample in a chromatograph down stream from the separation process.

Additionally or alternatively, the chromatography column assembly further comprises at least two frits. The at least two frits may include a metal crown frit seal.

Additionally or alternatively, the chromatography column assembly further comprises a connector structure located between a first of the plurality of columns and a second of the plurality of columns.

Additionally or alternatively, the connector structure includes a channel extending between a first frit of the first of the plurality of columns and a second frit of the second of the plurality of columns, and where a first cone distributor is located proximate the first frit for distributing and/or collecting fluid between the channel and the first frit, and where a second cone distributor is located proximate the second frit for distributing and/or collecting fluid between the channel and the second frit.

The connector structure may additionally or alternatively include a single frit configured to act as a fluidic channel between the first of the plurality of columns and the second of the plurality of columns and/or a channel extending between a first frit of the first of the plurality of columns and a screen of the second of the plurality of columns, where a cone distributor located proximate the first frit for distributing and/or collecting fluid between the channel and the first frit, and where a volume distributor is located proximate the screen. Additionally or alternatively, the connector includes channel extending between a first screen of the first of the plurality of columns and a second screen of the second of the plurality of columns, wherein a first volume distributor is located proximate the first screen, and wherein a second volume distributor is located proximate the second screen.

Additionally or alternatively, each of the plurality of columns includes an inner diameter of 2.1 mm and/or each of the plurality of columns is the same length.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1 depicts a schematic depiction of an example of how linear chromatographic velocity varies across the diameter of a chromatography column.

FIG. 2 depicts graphical representation of how a chromatographic peak for an analyte propagating through a chromatography column is affected by a variation in linear chromatographic velocity with radius.

FIG. 3 depicts a cross-sectional side view illustration of an example of an inlet end of a chromatographic column.

FIG. 4 depicts a prior art 2.1 mm inner diameter chromatography column having a length of 300 mm with a plot of asymptotic axial dispersion over the length of the column, in accordance with one embodiment.

FIG. 5 depicts a chromatography column assembly having a 2.1 mm inner diameter and a total length of 300 mm with a plot of asymptotic axial dispersion over the length of the chromatography column assembly, in accordance with one embodiment.

FIG. 6 depicts a chromatography column assembly having a 2.1 mm inner diameter and a total length of 300 mm with a plot of asymptotic axial dispersion over the length of the chromatography column assembly, in accordance with one embodiment.

FIG. 7 depicts another chromatography column assembly having a 2.1 mm inner diameter and a total length of 300 mm with a plot of asymptotic axial dispersion over the length of the chromatography column assembly, in accordance with one embodiment.

FIG. 8A depicts a chromatogram for an example of a separation by size exclusion chromatography run with the single 300 mm chromatography column of FIG. 5, in accordance with one embodiment.

FIG. 8B depicts a chromatogram for an example of a separation by size exclusion chromatography run with the chromatography column assembly of FIG. 6, in accordance with one embodiment.

FIG. 8C depicts a chromatogram for an example of a separation by size exclusion chromatography run with the chromatography column assembly of FIG. 7, in accordance with one embodiment.

FIG. 8D depicts a chromatogram for an example of a separation by size exclusion chromatography run with the chromatography column assembly of FIG. 8, in accordance with one embodiment.

FIG. 9 depicts a schematic representation of a packing method, in accordance with one embodiment.

FIG. 10A depicts a cross-sectional side view of a connection between two short columns, in accordance with one embodiment.

FIG. 10B depicts an enlarged cross-sectional side view of the connection between two short columns of FIG. 10A, in accordance with one embodiment.

FIG. 11 depicts a cross-sectional side view of another connection between two columns, in accordance with one embodiment.

FIG. 12 depicts a cross-sectional side view of another connection between two columns in accordance with one embodiment.

FIG. 13 depicts a cross-sectional side view of another connection between two columns in accordance with one embodiment.

FIG. 14 depicts a schematic view of a liquid chromatography system including a chromatography column assembly, in accordance with one embodiment.

### DETAILED DESCRIPTION

Reference in the specification to an embodiment or example means that a particular feature, structure or characteristic described in connection with the embodiment or example is included in at least one embodiment or example of the teaching. References to a particular embodiment or example within the specification do not necessarily all refer to the same embodiment or example.

The present teaching will now be described in detail with reference to exemplary embodiments or examples thereof as shown in the accompanying drawings. While the present teaching is described in conjunction with various embodiments and examples, it is not intended that the present teaching be limited to such embodiments and examples. On the contrary, the present teaching encompasses various alternatives, modifications, and equivalents, as will be appreciated by those of skill in the art. Moreover, features illustrated or described for one embodiment or example may be combined with features for one or more other embodiments or examples. Those of ordinary skill having access to the teaching herein will recognize additional implementations, modifications, and embodiments, as well as other fields of use, which are within the scope of the present disclosure as described herein.

In brief overview, embodiments and examples disclosed herein are directed to a chromatography column assembly which can operate under a 300 mm long dispersion regime such that its overall axial dispersion coefficient remains as small as possible compared to the maximum axial dispersion coefficient expected under an asymptotic dispersion regime for an infinitely long column.

It may take some distance along a column for the axial dispersion coefficient to develop into its asymptotic value, as described herein below. This may be particularly true for slow diffusive analytes such as large biomolecules (e.g., mAbs, sub units, and other cell impurities) because it takes too long for these slow diffusive analytes to probe multiple times all the radial positions across a column.

The present invention contemplates dividing a given length of dispersion regime (e.g., a 300 mm regime) into N shorter columns of length Lᵢ, where the total dispersion regime length (L)=N×Lᵢ. It is contemplated that these N shorter columns are connected in series, whereby each are operated under pre-asymptotic dispersion regimes, which generate the smallest axial dispersion coefficients. For large biomolecules, the plate heigh of each individual short column may be smaller than that of a single column (e.g., a 300 mm column). Therefore, the efficiency of the multiple inter-connected short columns having the same total length may be larger than that of a single column of 300 mm length.

It is further contemplated to design and build multiple (e.g., in the case of a 300 mm regime, N=6) shorter columns and connect the shorter columns in series using zero dead volume column connectors such as those described herein below. It is further contemplated that each shorter column may be packed under identical pressure and same bed density using a shower-head packing system.

It should be understood that the solutions proposed herein do not intend to eliminate the radial flow heterogeneity across a column diameter, as the columns described herein may still be packed at very high pressures, as is common in the art.

As described above, the wall-to-center bed heterogeneity for a liquid chromatography column due to particle bed packing typically leads to a variation in linear chromatographic velocity across the column radius and results in chromatographic distortion. This variation in velocity distorts the chromatographic band and degrades column performance and resolution power. FIG. 1 is a schematic representation of how the linear chromatographic velocity varies across the diameter of a column 10. The two large arrows along the column axis indicate the flow direction. The column 10 includes a stainless steel tube 12 having a packed particle bed 14 with a frit 16 at the inlet end and another frit 18 at the outlet end. Curve 20 imposed on the illustration is a graphical depiction of an example of a velocity profile 20 across the diameter of the column 10. The velocity profile 20 indicates the magnitude of individual linear velocity vectors along the diameter where each velocity vector indicates the linear velocity in a direction parallel to the column axis 24. The greatest velocity is along the column axis 24 and the velocity decreases with increasing radial distance from the column axis 24. Although there is a region near the inner surface of the tube 12 where the velocity increases due to large void spacing where the spherical particles are tangent to the inner surface, this region exits only over a small radial distance (e.g., 2 μm to 10 μm, according to particle size) and is insignificant with respect to the full cross-sectional area of the column 10.

Introduction of a plug of analyte at the inlet (frit 16) of the column bed 14 corresponds to the analyte being received at the same time across the full cross-section of the inlet. Ignoring the small radial distance adjacent to the tube inner surface described above, the plug of analyte begins to propagate through the packed particle bed 14 such that analyte along the column axis 24 travels through the column 10 fastest with analyte linear velocity decreasing with increasing radial distance from the axis 24 according to the radially varying velocity profile 20. The velocity profile 20 in FIG. 1 is exaggerated to illustrate this effect.

Long columns can be particularly problematic because the analyte at greater radial distances from the axis 24 (i.e., in the “outer region”) remains in its region for a significant time and increasingly lags behind analyte distributed closer to and along the axis 24 of the column (i.e., in the “central region”) during the full migration along the length of the column 10.

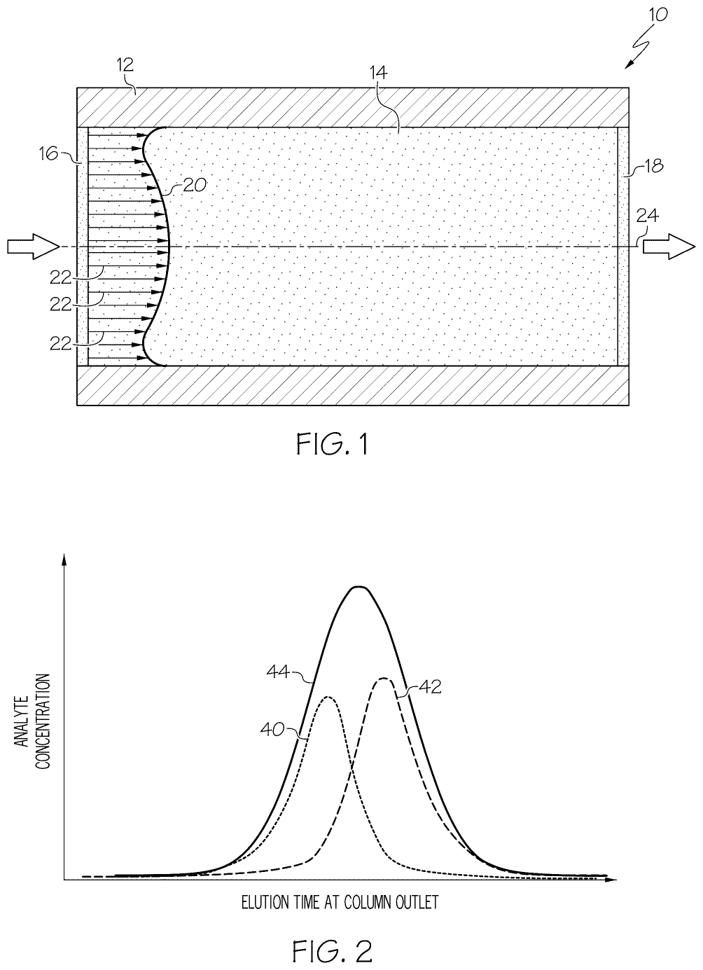

FIG. 2 is a graphical representation of how a chromatographic peak for an analyte propagating through a chromatography column is affected by the variation in linear velocity with radius. Plot 40 is a chromatographic peak for a portion of the analyte on and near to the column axis and plot 42 is a chromatographic peak for the same analyte in an annular region of greater radial distance from the column axis out to near the column wall. The analyte nearest the axis elutes from the column at an earlier time than the analyte in the outer region. The resulting analyte peak 44, which is effectively the combination of the two peaks 40 and 42, exhibits significant broadening with respect the peak widths of the individual peaks 40 and 42.

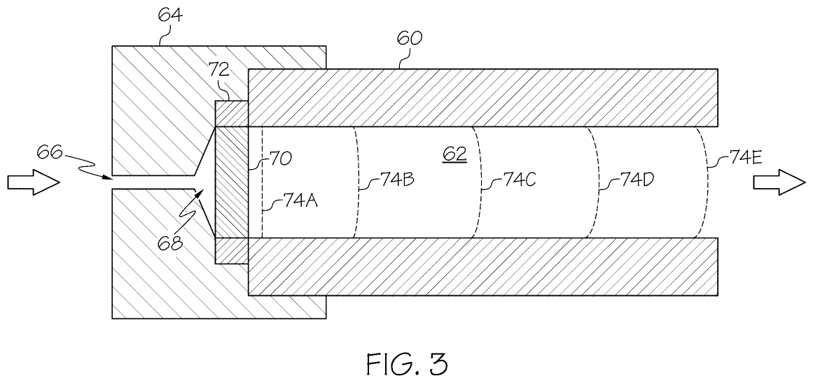

FIG. 3 is a cross-sectional side view illustration of the inlet end of a chromatographic column. The column includes a column bed 62 comprised of a stationary phase material disposed inside the inner surface of a column wall 60. The column wall 60 is an open tube and may be formed of one or more of stainless steel, polyether ether ketone (PEEK), titanium, glass and the like which optionally may be coated on the inner surface.

An inlet end nut 64 is secured to the column wall 60 at the inlet end of the column bed 62. Similarly, an outlet end nut (not shown) is secured to the column wall 60 at the opposite (outlet) end of the column bed 62. The inlet end nut 64 includes an inlet port 66 to receive the flow of mobile phase and injected sample and further includes a distributor 68 to expand the received flow into a substantially uniform flow across the inlet face of the frit 70. As illustrated, the distributor 68 includes a conical surface or opening which acts as a distributor to expand the received flow into a substantially uniform flow across the inlet face of the frit 70. This structure provides the concept of flow distribution. The distributor may include a full cone angle of approximately 170°, for example. In alternative embodiments, the full cone angle may be different. Alternatively, a different form of distributor, or device acting as a distributor, may be used. A frit 70 in the form of a flat disk is disposed at the wide end of the cone and the inlet end of the column bed 62 with a gasket 72 or O-ring.

It should be understood that the outlet end nut may be similar in structure to the inlet end nut 64 and is arranged in a mirror image configuration at the outlet end of the column bed 62. Thus, the conical opening in the outlet end nut functions as a collector to receive the mobile phase flow from the outlet end of the outlet frit and provides the flow through an outlet port. For example, the flow from the outlet port may be conducted to a detector, a fraction collector and/or other modules accessing the eluent having the separated components of the chromatographic run.

During a chromatographic separation, a flow of mobile phase (and any injected sample) is received at the inlet port 66 and expanded such that the flow at the inlet face of the frit 70 is substantially constant regardless of inlet face location. The flow passes through the thickness of the frit 70 and through the column bed 62 before being collected at the column end nut. The dashed lines 74A to 74E (generally 74) in the figure indicate how the flow is changed by the wall effect as it propagates through the column. Downstream from the frit 70 just inside the inlet end of the column bed 62, the flat dashed line 74A indicates how the flow near the column axis and the flow near the column wall have progressed nearly the same distance in the axial direction. The velocity variation across the column bed diameter results in the flow at the center increasingly “outrunning” the flow near the column wall 60 (dashed lines 74B to 74E). The bowing in the dashed lines is exaggerated to demonstrate the effect more clearly. Thus, the flow in the central region disposed about the column axis exits the outlet end of the column bed 62 before the flow in the outer region closer to the column wall 60.

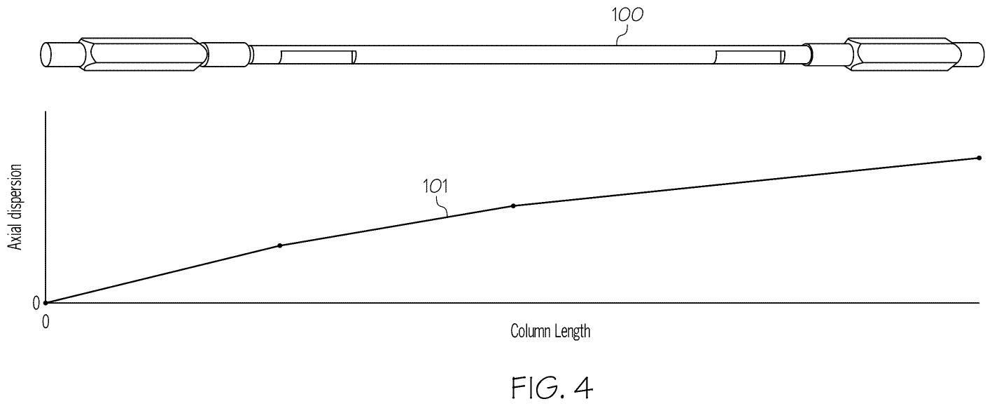

FIG. 4 depicts a prior art 2.1 mm inner diameter chromatography column 100 having a length of 300 mm with a plot 101 of asymptotic axial dispersion over the length of the column, in accordance with one embodiment. The chromatography column 100 may represent any standard chromatography column having a standard length of at least 100 or 150 mm, such as a 100 mm column, a 150 mm column, a 250 mm column, or a 300 mm column. The chromatography column 100 may further represent any standard column diameter, such as 4.6 mm, 4 mm, 3.9 mm, 3 mm, 2.1 mm, 2 mm, or 1 mm. For the purposes of the present example shown, the chromatography column 100 may be a 2.1 mm inner diameter column having a 300 mm length. As shown, the asymptotic axial dispersion over the length of the column increases along the plot 101. Because the chromatography column 100 has a long length of 300 mm, the asymptotic axial dispersion is high at the end of the length of the chromatography column, as described hereinabove.

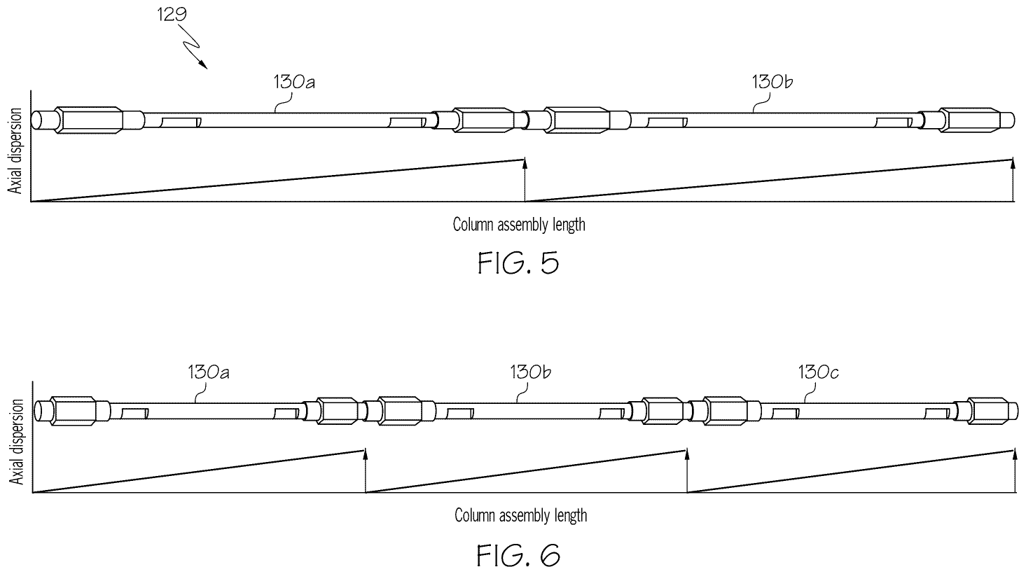

FIG. 5 depicts a chromatography column assembly 109 having a 2.1 mm inner diameter and a total length of 300 mm with a plot of asymptotic axial dispersion over the length of the chromatography column assembly 109, in accordance with one embodiment. Unlike the standard chromatography column 100 shown in FIG. 4, the chromatography column assembly 109 includes a first chromatography column 110a and a second chromatography column 110b. Thus, the chromatography column assembly 109 divides a total standard length (e.g., 300 mm) into a plurality of sub-parts which comprise the single assembly. In the case of the chromatography column 109, the number of sub-parts 110a, 110b is two. As shown, the asymptotic axial dispersion over the length of the column increases along each respective plot 111a, 111b. However, the redistribution of the sample dispersion between the first and second columns 110a, 110b maintains a lower total asymptotic axial dispersion. This sample redistribution may be provided by a specific frit and/or connector arrangement between the sub- parts, as described herein below.

FIG. 6 depicts a chromatography column assembly 119 having a 2.1 mm inner diameter and a total length of 300 mm with a plot of asymptotic axial dispersion over the length of the chromatography column assembly 119, in accordance with one embodiment. Unlike the standard chromatography column 100 shown in FIG. 4, the chromatography column assembly 119 includes a first chromatography column 120a, a second chromatography column 120b, and a third chromatography column 120c. Thus, the chromatography column assembly 119 divides the same total standard length as the previous embodiments (e.g., 300 mm) into a plurality of sub-parts which comprise the single assembly. In the case of the chromatography column 119, the number of sub-parts 120a, 120b, 120c, is three. As shown, the asymptotic axial dispersion over the length of the column increases along each respective plot 121a, 121b, 121c. However, the redistribution of the sample dispersion between the first and second columns 120a, 120b, and the redistribution of the sample dispersion between the second and third columns 120b, 120c maintains a lower total asymptotic axial dispersion. This sample redistribution may be provided by a specific frit and/or connector arrangement between the sub-parts, as described herein below.

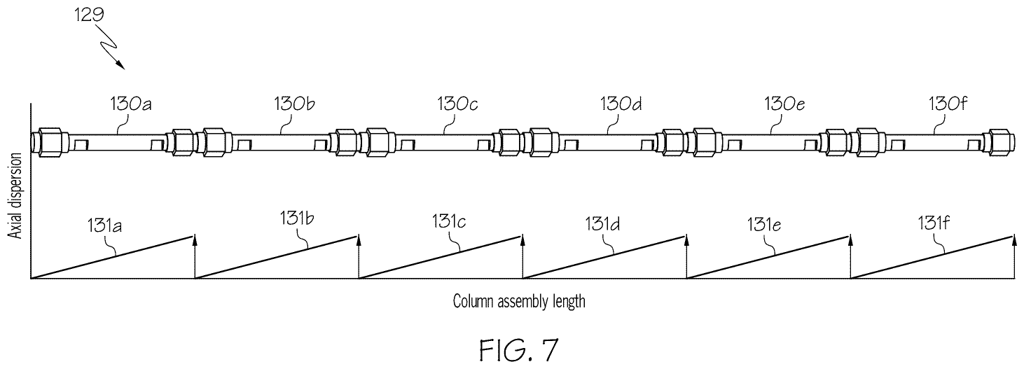

FIG. 7 depicts another chromatography column assembly 129 having a 2.1 mm inner diameter and a total length of 300 mm with a plot of asymptotic axial dispersion over the length of the chromatography column assembly 129, in accordance with one embodiment. Unlike the standard chromatography column 100 shown in FIG. 4, the chromatography column assembly 129 includes a first chromatography column 130a, a second chromatography column 130b, a third chromatography column 130c, a fourth chromatography column 130d, a fifth chromatography column 130e, and a sixth chromatography column 130f. Thus, the chromatography column assembly 129 divides the same total standard length as the previous embodiments (e.g., 300 mm) into a plurality of sub-parts which comprise the single assembly. In the case of the chromatography column 129, the number of sub-parts 130a, 130b, 130c, 130d, 130e, 130f is six. As shown, the asymptotic axial dispersion over the length of the column increases along each respective plot 131a, 131b, 131c, 131d, 131e, 131f. However, the redistribution of the sample dispersion between the columns 130a, 130b, 130c, 130d, 130e, 130f maintains a lower total asymptotic axial dispersion. This sample redistribution may be provided by a specific frit and/or connector arrangement between the sub-parts, as described herein below.

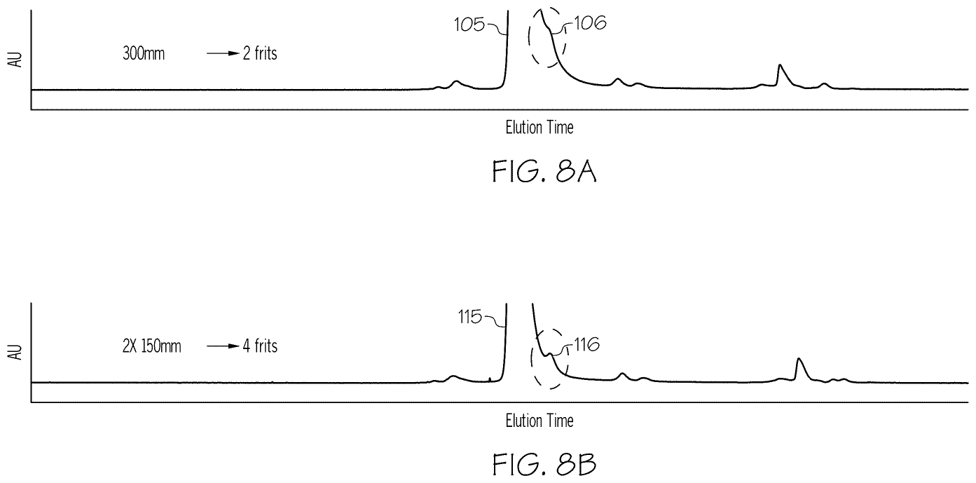

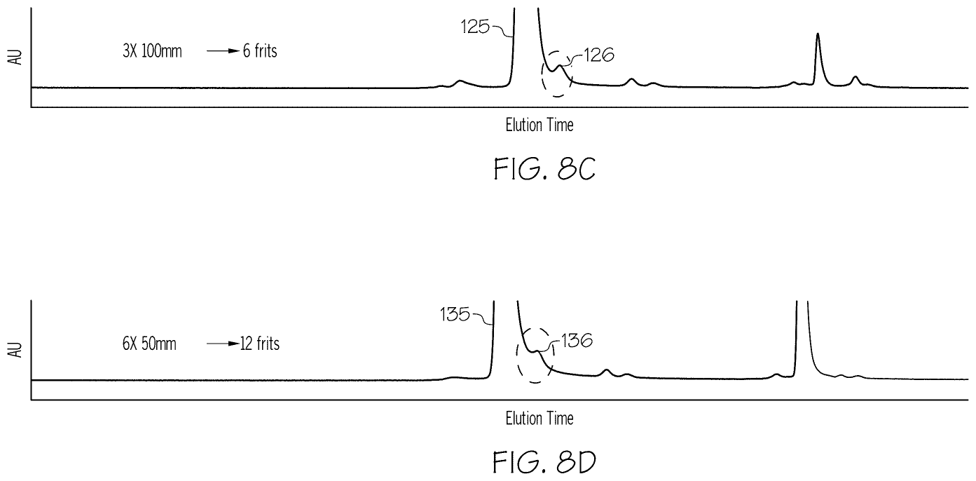

The problem of radial velocity variation can be critical for slow diffusive analytes. FIG. 8A depicts a chromatogram for an example of a separation by size exclusion chromatography run with the single 300 mm chromatography column 100 of FIG. 5, in accordance with one embodiment. The separation utilized a 2.1 mm×300 mm Size Exclusion Chromatography column from Waters Corporation of Milford, MA. The chromatogram includes a chromatographic peak 105 for a monoclonal antibody having a 150 kDa mass and a 97% abundance. Also shown is a chromatographic peak 106 for an impurity in the form of a non-reduced monoclonal antibody subunit having a 121 kDa mass and a 3% abundance. The upper portion of the larger chromatographic peak 105 is not shown so as to enable observation of the smaller impurity chromatographic peak 106. The presence of the impurity is nearly masked due to the high abundance of the monoclonal antibody relative to the abundance of the subunit in combination with the poor chromatographic resolution resulting from the radial velocity variation across the column. Thus, a means of reducing the radial variation in linear velocity is desirable for improving the chromatographic resolution.

FIG. 8B depicts a chromatogram for an example of a separation by size exclusion chromatography run with the chromatography column assembly 109 of FIG. 6, in accordance with one embodiment. The chromatogram includes a chromatographic peak 115 for the same monoclonal antibody having a 150 kDa mass and a 97% abundance. Also shown is a chromatographic peak 116 for an impurity in the form of a non-reduced monoclonal antibody subunit having a 121 kDa mass and a 3% abundance. The upper portion of the larger chromatographic peak 115 is not shown so as to enable observation of the smaller impurity chromatographic peak 116. The presence of the impurity is now far less masked because of the radial velocity variation across the column assembly 109, compared to the column 100 of FIG. 5. Thus, the column assembly 109 provides a means of reducing the radial variation in linear velocity for improving the chromatographic resolution.

FIG. 8C depicts a chromatogram for an example of a separation by size exclusion chromatography run with the chromatography column assembly 119 of FIG. 7, in accordance with one embodiment. The chromatogram includes a chromatographic peak 125 for the same monoclonal antibody having a 150 kDa mass and a 97% abundance. Also shown is a chromatographic peak 126 for an impurity in the form of a non-reduced monoclonal antibody subunit having a 121 kDa mass and a 3% abundance. The upper portion of the larger chromatographic peak 125 is not shown so as to enable observation of the smaller impurity chromatographic peak 126. The presence of the impurity is even less masked because of the radial velocity variation across the column assembly 119, compared to the column 100 of FIG. 5 and the column assembly 109 of FIG. 6. Thus, the column assembly 119 provides an even more improved means of reducing the radial variation in linear velocity for improving the chromatographic resolution.

FIG. 8D depicts a chromatogram for an example of a separation by size exclusion chromatography run with the chromatography column assembly 129 of FIG. 8, in accordance with one embodiment. The chromatogram includes a chromatographic peak 135 for the same monoclonal antibody having a 150 kDa mass and a 97% abundance. Also shown is a chromatographic peak 136 for an impurity in the form of a non-reduced monoclonal antibody subunit having a 121 kDa mass and a 3% abundance. The upper portion of the larger chromatographic peak 135 is not shown so as to enable observation of the smaller impurity chromatographic peak 136. With the addition of six separate columns, the presence of the impurity is less masked because of the radial velocity variation across the column assembly 129, compared to the column 100 of FIG. 5. However, with the six smaller columns of the assembly 129, there is more masking than the three smaller columns of the assembly 119. Thus, the column assembly 129 provides a means of reducing the radial variation in linear velocity for improving the chromatographic resolution relative to a single column, but does not perform as well as the three smaller columns of the assembly 119.

Therefore, it may be desirable to determine a number of sub-parts which maximizes the chromatographic resolution relative to a single column. Increasing the number of sub-parts may actually decrease the chromatographic resolution as a result of increased extra column dispersion volume. Therefore, determining a number of sub-parts which maximizes the chromatographic resolution is an important step in designing the column assemblies described herein.

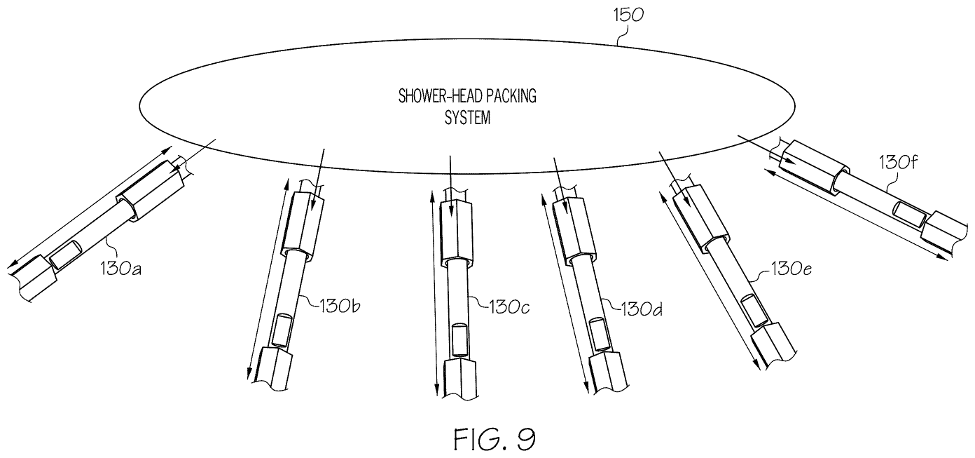

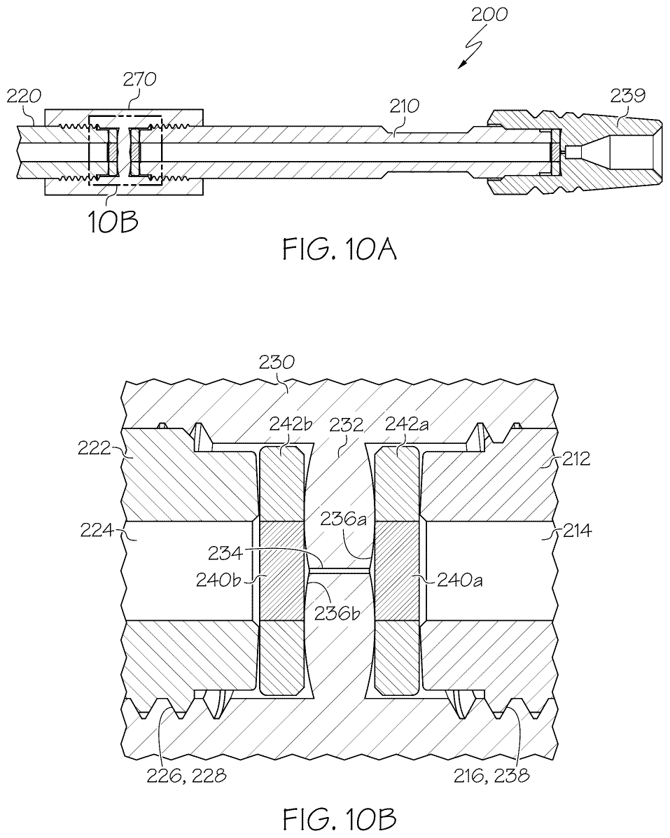

FIG. 9 depicts a schematic representation of a packing method, in accordance with one embodiment. The packing method may include a common manifold which provides uniform distribution of the pressure and packing materials to all columns attached. In accordance with such a method, a plurality of chromatography columns may be packed with particle bed packing material via a single pressurized head and a plurality of pressurized packing channels. This type of “shower-head” packing may be performed by a shower-head packing system 150 under high pressures such that each of the chromatography columns 130a, 130b, 130c, 130d, 130e, 130f of the sub-parts in the assembly have the same exact shared change in pressure during the packing process (i.e. packed during the same process, being packed by the same head, at the same time, under the same pressure). However, in other embodiments contemplated, the columns may be packed with different efficiency and/or packing densities within control specifications and/or parameters.

Once packed, a chromatography column assembly in accordance to embodiments described herein may be assembled such that each of the short sub-parts is connected in series. FIG. 10A depicts a cross-sectional side view of a connection between two short columns 210, 220, in accordance with one embodiment. FIG. 10B depicts an enlarged cross-sectional side view of the connection between two short columns 210, 220 of FIG. 10A, in accordance with one embodiment. As shown, a column assembly 200 includes at least two of the sub-part short columns 210, 220, connected by a connector structure 230 located between each of the first and second short columns 210, 220. At one end of the column assembly 200, an end connector 239 is shown which is configured to receive a fitting for fluidic connection to the rest of a chromatography system. While not shown, it should be understood that the column assembly 200 includes another end connector at an opposite end of the column assembly 200 as the end connector 240.

The columns 210, 220 each include respective packed particle beds 214, 224, along with surrounding outer bodies 212, 222. Between each of the sub-part short columns 210, 220 of the column assembly 200 is the connector structure 230. The connector structure 230 includes a middle body 232 within which a channel 234 extends between a first frit 240a of the first column 210 and a second frit 240b of the second column 220. Each of the frits 240a, 240b may be a porous structure configured to redistribute fluid received at one end as the fluid passes through the frit. The frits 240a, 240b may be supported by respective metal rings 242a, 242b, respectively. The respective metal rings 242a, 242b may be configured to seal off the outer diameter of the respective frits 240a, 240b, and facilitate in making fluidic seals on the flat face surface of the rings 242a, 242b.

The channel 234 may be a narrow channel having any appropriate length and diameter, and may extend between the first frit 240a and the second frit 240b. The connector structure 230 may further include a cone distributor 236a that is located proximate the first frit 240a, and a second cone distributor 236b that is located proximate the second frit 240b. Each of the cone distributors 236a, 236b may be conical in shape and may be configured for uniformly distributing fluid to a frit or uniformly collect from a frit.

Extending from each axial side of the connector body 230 is an extending internally threaded structure 238, 248 for connecting the connector body 230 to external threads 216, 226 of each of the first column 210 and the second column 220, respectively.

The column assembly 200 may include only the two total sub-parts 210, 220 spanning across an entire standard length (such as 300 mm, like the assembly shown in FIG. 5). In such an embodiment, the column assembly 200 may include a total of four frits. While not enlarged, each of the sub part column ends may include frits. It may also be the case that the column assembly 200 includes any number of additional sub-parts (not shown). For example, if a column assembly includes three sub-part short columns, the column assembly may include a total of six frits. Alternatively, if a column assembly includes six sub-part short columns, the column assembly may include a total of twelve frits.

While the connector 230 may be an exemplary connector structure which serves to connect the various sub-parts of the assembly, the connector 230 may be different than the specific embodiment depicted. For example a connector 230 which includes a single frit between the two sub-parts may be contemplated. Further, it may be possible to connect sub-parts without a frit structure (e.g., only deploying the cone distributors at the end of the column beds). In such embodiments, a thin screen structure may be used instead of a frit. Various other end structures for the connector 230 and/or the sub part short columns 210, 220 are contemplated in accordance with the concepts described herein.

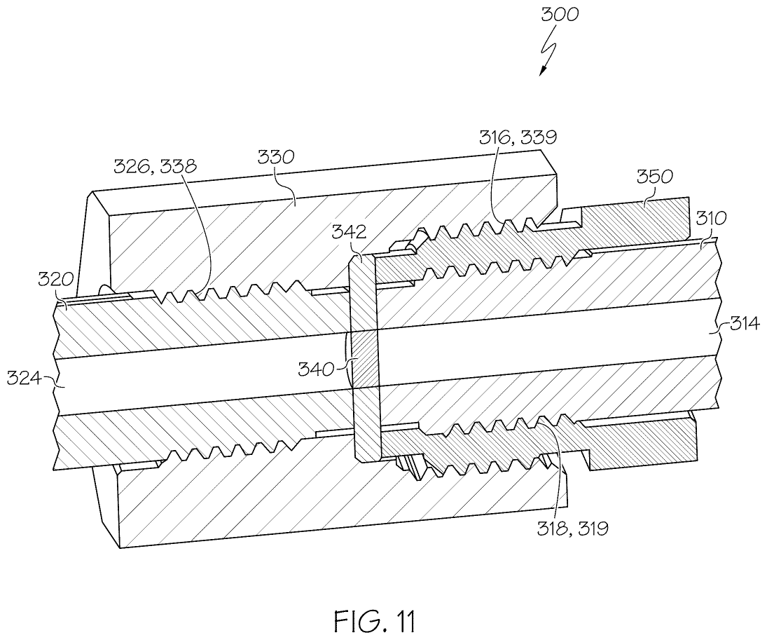

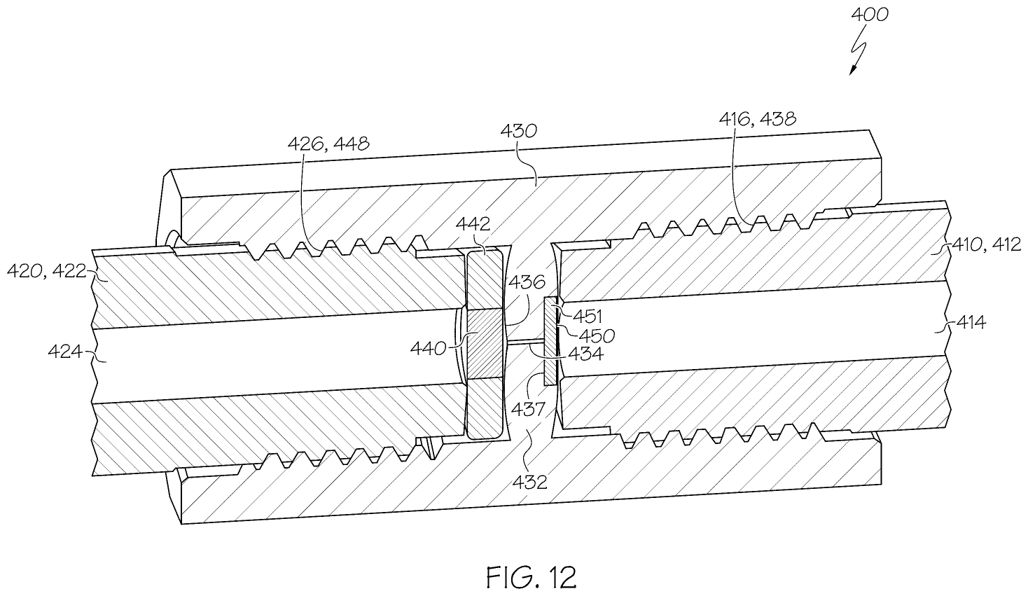

FIG. 11 depicts a cross-sectional side view of another connection between two columns, in accordance with one embodiment. As shown, a column assembly 300 includes at least two of the sub-part short columns 310, 320, connected by a connector structure 330 located between each of the first and second short columns 310, 320. At both ends of the column assembly 300, an end connector (not shown) may be provided, like the end connector 239 described herein above.

The columns 310, 320 each include respective packed particle beds 314, 324, along with surrounding outer bodies 312, 322. Between each of the sub-part short columns 310, 320 of the column assembly 300 is the connector structure 330.

The connector structure 330 includes a single frit 340 located between each of the first column 310 and the second column 320. The frit 340 may be a porous structure configured to redistribute fluid received at one end as the fluid passes through the frit 340. The frit 340 may be supported by a metal ring 342. The metal ring 342 may be configured to seal off the outer diameter of the frit 340, and facilitate in making fluidic seals on the flat face surface of the ring 342.

Extending from a first axial side of the connector body 330 is an extending internally threaded structure 338 for connecting to external threads 326 of the second column 320. Extending from a second axial side of the connector body 330 is another extending internally threaded structure 339 which may be dimensioned with a larger diameter than the externally threaded structure 338 to accommodate an intermediate biasing nut 350. The intermediate biasing nut 350 may be configured to create a biasing force with an outer portion of the metal ring 342. The intermediate biasing nut 350 may be screwed into the extending internally threaded structure 339 first. The intermediate biasing nut 350 may include its own external threads 316 and internal threads 318. The external threads 316 of the intermediate biasing nut 350 may be configured to engage with the extending internally threaded structure 339 of the connector body 330. The internal threads 318 of the intermediate biasing nut 350 may be configured to engage with external threads 319 of the first column 310. Thus, after the intermediate biasing nut 350 is threaded into the connector body 330, the first column 310 may be threaded into the intermediate biasing nut 350 to create the assembly. This structure may ensure a tight connection on each side of the single frit 340.

The column assembly 300 may include only the two total sub-parts 310, 320 spanning across an entire standard length (such as 300 mm, like the assembly shown in FIG. 5). In such an embodiment, the column assembly 300 may include a total of three frits. Thus, in this embodiment, each connector structure 330 between two sub-columns may include a single frit. It may also be the case that the column assembly 300 includes any number of additional sub-parts (not shown). For example, if a column assembly 300 includes three sub-part short columns, the column assembly 300 may include a total of four frits (one at each end, and one at each respective middle connection). Alternatively, if a column assembly 300 includes six sub- part short columns, the column assembly 300 may include a total of seven frits (again one at each end, and one at each respective middle connection).

FIG. 12 depicts a cross-sectional side view of yet another connection between two columns in accordance with one embodiment. The connection shown in FIG. 12 includes both a frit and a thin screen, as described herein below.

Herein, a “frit” is defined as a structurally supported device which includes a porous packing material. A frit generally includes a depth of the porous packing material for distribution of fluid. A frit is generally structurally supportive (i.e., with a metal ring surrounding the packing material) in order to hold the packing material. While not always present, a cone may be deployed between a frit and a fluidic channel which may act to supply and collect (depending on if the frit is acting as an outlet or inlet) fluid uniformly to and/or from the frit. The porous packing material within the frit enables appropriate sample dispersion.

In contrast to a “frit”, a “thin screen” herein is defined as a thin screen structure without the depth of material provided by the frit. A screen is not structurally supportive, and does not include a depth of packing material, but instead includes a thin layer of mesh or the like for filtration. A thin screen as described herein may include a distributor volume, or open volume, adjacent to the thin screen which acts to supply and/or collect fluid to and from the screen and to provide support for the screen.

As shown, a column assembly 400 includes at least two of the sub-part short columns 410, 420, connected by a connector structure 430 located between each of the first and second short columns 410, 420. At both ends of the column assembly 400, an end connector (not shown) may be provided, like the end connector 239 described herein above.

The columns 410, 420 each include respective packed particle beds 414, 424, along with surrounding outer bodies 412, 422. Between each of the sub-part short columns 410, 420 of the column assembly 400 is the connector structure 430.

The connector structure 430 includes a middle body 432 within which a channel 434 extends between a frit 440 of the second column 420 and a thin screen 450 of the first column 420. The frit 440 may be a porous structure configured to redistribute fluid received at one end as the fluid passes through the frit 440. The frit 440 may be supported by a metal ring 442. The metal ring 442 may be configured to seal off the outer diameter of the frit 440, and facilitate in making fluidic seals on the flat face surface of the ring 442.

The channel 434 may be a narrow channel having any appropriate length and diameter, and may extend between the first frit 440 and the thin screen 250. The connector structure 430 may further include a cone distributor 436 that is located proximate the first frit 440. A distributor volume 451 is located proximate the thin screen 450. The distributor volume 451 may be bored or otherwise fashioned or machined into the middle body to a base 437 which includes an opening for the channel 434. The distributor volume 451 may be an empty volume located between the thin screen 450 and the base 437 and channel 434 which acts to supply and/or collect fluid to and/or from the thin screen 450 and may further provide support for the thin screen 450.

While the embodiment shown includes a bored distributor volume 451, it should be understood that the distributor volume may be dimensioned as a cone, similar to the cone distributor 436. In other embodiments, the distributor volume 451 may be a separate component having an open volume placed proximate the surface of the thin screen 450 and placed within a machined pocket of the connector. Still further, the distributor volume 451 may include a component that includes a volume chamber or space which is formed integral with the screen or otherwise bonded to the screen. Alternatively, as shown in FIG. 12, the distributor volume 450 may simply be machined or otherwise etched into the connector 430 to create the open volume behind the thin screen 450. Extending from each axial side of the connector body 430 is an extending internally threaded structure 438, 448 for connecting the connector body 430 to external threads 416, 426 of each of the first column 410 and the second column 420, respectively.

The column assembly 400 may include only the two total sub-parts 410, 420 spanning across an entire standard length (such as 300 mm, like the assembly shown in FIG. 5). In such an embodiment, the column assembly 400 may include a total of three frits. Thus, in this embodiment, each connector structure 430 between two sub-columns may include a single frit. It may also be the case that the column assembly 400 includes any number of additional sub-parts (not shown). For example, if a column assembly 400 includes three sub-part short columns, the column assembly 400 may include a total of four frits (one at each end, and one at each respective middle connection). Alternatively, if a column assembly 400 includes six sub-part short columns, the column assembly 400 may include a total of seven frits (again one at each end, and one at each respective middle connection).

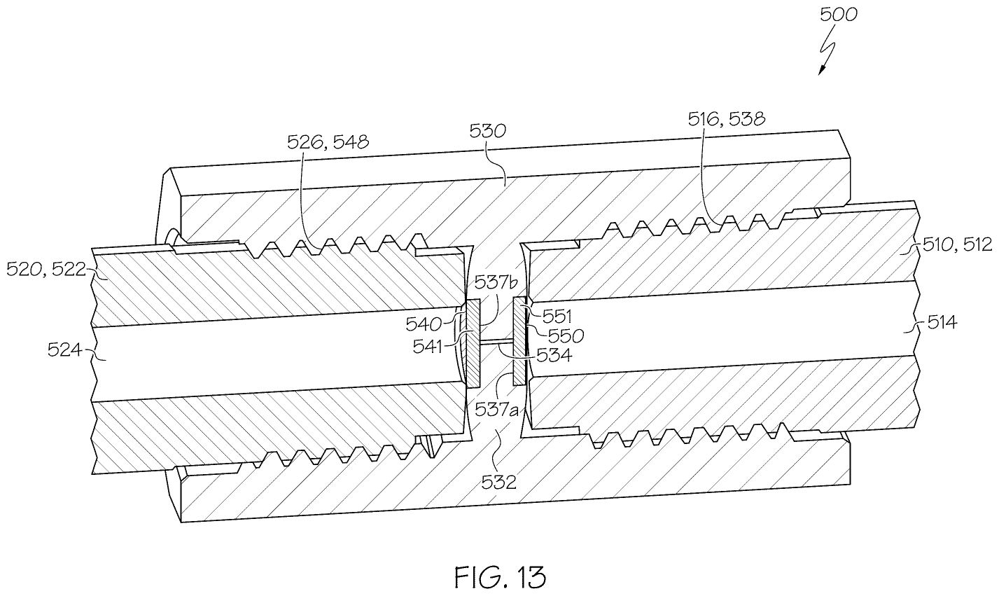

FIG. 13 depicts a cross-sectional side view of another connection between two columns in accordance with one embodiment. As shown, a column assembly 500 includes at least two of the sub-part short columns 510, 520, connected by a connector structure 530 located between each of the first and second short columns 510, 520. At both ends of the column assembly 500, an end connector (not shown) may be provided, like the end connector 239 described herein above.

The columns 510, 520 each include respective packed particle beds 514, 524, along with surrounding outer bodies 512, 522. Between each of the sub-part short columns 510, 520 of the column assembly 500 is the connector structure 530.

The connector structure 530 includes a middle body 532 within which a channel 534 extends between a thin screen 540 of the second column 520 and thin screen 550 of the first column 520. The thin screens 540, 550 may be the same as the thin screen 450 described herein above, and may each include a respective distributor volume 541, 551, which may be the same as the distributor volume 451 described herein above.

The channel 534 may be a narrow channel having any appropriate length and diameter, and may extend between the thin screens 540, 550. In the embodiment shown, a flat plate distributor 537a is bored or otherwise fashioned or machined into the middle body dimensioned to receive the thin screen 550. Similarly, a flat plate distributor 537b is bored or otherwise fashioned or machined into the middle body dimensioned to receive the thin screen 550. Thus, the thin screens 540, 550 may seat within the respective flat plate distributors 537a, 537b and abut the channel 534 proximate the respective columns 510, 520.

Extending from each axial side of the connector body 530 is an extending internally threaded structure 538, 548 for connecting the connector body 530 to external threads 516, 526 of each of the first column 510 and the second column 520, respectively.

The column assembly 500 may include only the two total sub-parts 510, 520 spanning across an entire standard length (such as 300 mm, like the assembly shown in FIG. 5). In such an embodiment, the column assembly 500 may include a total of two frits (one on each end of the assembly). Thus, in this embodiment, each connector structure 430 between two sub-columns may include no frits, but instead may include one or more flat screens. It may also be the case that the column assembly 500 includes any number of additional sub-parts (not shown). For example, if a column assembly 500 includes three sub-part short columns, the column assembly 500 may still include a total of two frits (one at each end) with four screens (two at each connector). Alternatively, if a column assembly 500 includes six sub-part short columns, the column assembly 500 may include a total of two frits (again one at each end) with ten screens (two at each connector).

Various combinations of the connectors shown in FIGS. 10A-13 are also contemplated within the same connector assembly. For example, a connector assembly may include one or more of the connectors 430 of FIG. 12 and additionally may include one or more of the connectors 530 of FIG. 13. By way of another example, a connector assembly may include one or more of the connectors 230 of FIG. 10A-10B and additionally may include one or more of the connectors 330 of FIG. 11. In still another example, a connector assembly may include one or more of each of the connectors 230, 330, 430, 530, or any combination thereof. It should be understood that any combination of the connectors 230, 330, 430, 530 are contemplated within a single column assembly in accordance with the principles described herein.

Still further, while distributors and/or distributor volumes described herein may be open volumes for distributing fluid adjacent to the screens and/or frits, in other embodiments, the distributors and distributor volumes may not necessarily be a fully empty volume. For example, the distributors and/or distributor volumes described herein may be fractal flow channels distributing the main narrow central flow over a larger surface area.

Chromatographic methods are also contemplated, in accordance with the principles described herein. For example, methods may include determining a chromatographic length for a separation process and then dividing the chromatographic length into a plurality of sub-parts. The sub-parts may each be equal sub-parts. In other embodiments, the sub-parts may be unequal lengths. Alternatively, the sub-parts may be unequal length sub-parts. Methods may then include assembling a chromatography column assembly that includes a plurality of columns connected in series. The chromatography column assembly may thus be configured so that each of the plurality of columns extends across one of the plurality of sub-parts such that the plurality of columns together equal the total determined chromatographic length. Methods may then include performing a separation process such that a sample sequentially moves through each of the plurality of columns connected in series and detecting the sample in a chromatograph down stream from the separation process.

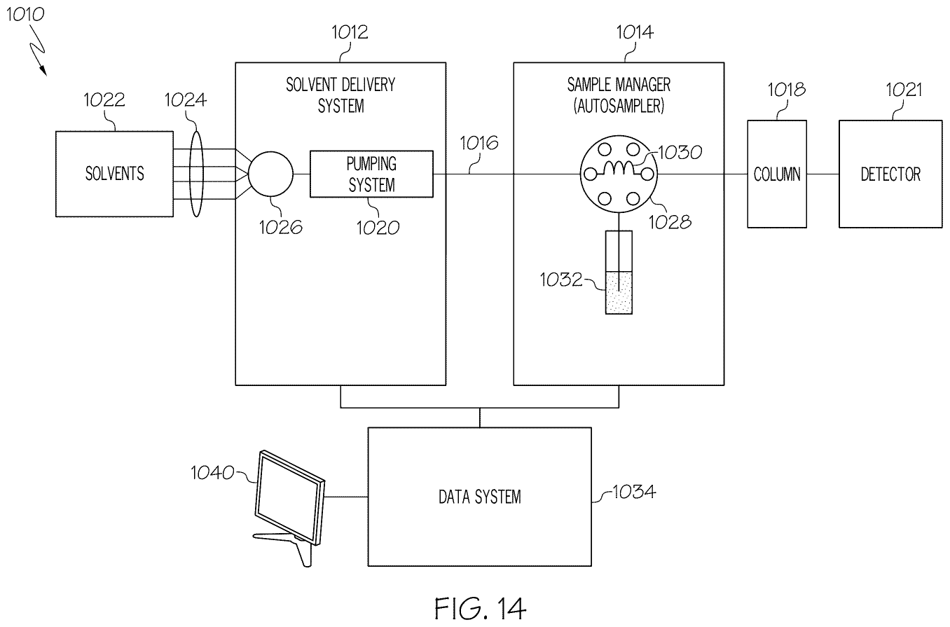

The features of the chromatography column assemblies described herein may be applicable to any liquid chromatography system configured to deliver samples into a chromatographic flow stream. As one example, FIG. 14 depicts a schematic view of a liquid chromatography system including a chromatography column assembly, in accordance with one embodiment. The liquid chromatography system 1010 includes a solvent delivery system 1012 in fluidic communication with a sample manager 1014 (also called an injector or an autosampler) through tubing 1016. The sample manager 1014 is in fluidic communication with a chromatographic column 1018. A detector 1021 for example, a mass spectrometer, is in fluidic communication with the column 1018 to receive the elution.

The solvent delivery system 1012 includes a pumping system 1020 in fluidic communication with solvent reservoirs 1022 from which the pumping system 1020 draws solvents (liquid) through tubing 1024. In one embodiment, the pumping system 1020 may be embodied by a low-pressure mixing gradient pumping system having two pumps fluidically connected in series, or alternatively a high pressure gradient pumping system, or further alternatively an isocratic pumping system. Any type of mechanism of pumping solvents may be represented by the pumping system 1020. In the low-pressure gradient pumping system, the mixing of solvents occurs before the pump, and the solvent delivery system 1012 has a mixer 1026 in fluidic communication with the solvent reservoirs 1022 to receive various solvents in metered proportions. This mixing of solvents (mobile phase) composition that varies over time (i.e., the gradient).

The pumping system 1020 is in fluidic communication with the mixer 1026 to draw a continuous flow of gradient therefrom for delivery to the sample manager 1014. Examples of solvent delivery systems that can be used to implement the solvent delivery system 1012 include, but are not limited to, the ACQUITY Binary Solvent Manager the ACQUITY Quaternary Solvent Manager, or the ALLIANCE iS HPLC system, manufactured by Waters Corp. of Milford, Mass.

The sample manager 1014 may include an injector valve 1028 having a sample loop 1030. The sample manager 1014 operates in one of two states: a load state and an injection state. In the load state, the position of the injector valve 1028 is such that the sample manager loads the sample 1032 into the sample loop 1030. The sample 1032 is drawn from a vial contained by a sample vial carrier. “Sample vial carrier” herein means any device configured to carry a sample vial such as a well plate, sample vial carrier, or the like. In the injection state, the position of the injector valve 1028 changes so that the sample manager 1014 introduces the sample in the sample loop 1030 into the continuously flowing mobile phase from the solvent delivery system. The mobile phase thus carries the sample into the column 1018. In other embodiments, a flow through needle (FTN) may be utilized instead of a Fixed-Loop sample manager. Using an FTN approach, the sample may be pulled into the needle and then the needle may be moved into a seal. The valve may then be switched to make the needle in-line with the solvent delivery system.

The liquid chromatography system 1010 further includes a data system 1034 that is in signal communication with the solvent delivery system 1012 and the sample manager 1014. Signal communication among the various systems and instruments can be electrical or optical, using wireless or wired transmission. A host computing system 1040 may be in communication with the data system 1034 by which a technician can download various parameters and profiles (e.g., an intake velocity profile) to the data system 1034.

While various examples have been shown and described, the description is intended to be exemplary, rather than limiting and it should be understood by those of ordinary skill in the art that various changes in form and detail may be made therein without departing from the scope of the invention as recited in the accompanying claims.

What is claimed is:

1. A chromatography column assembly comprising:
a standard column length of at least 100 mm; and
a plurality of columns connected in series, wherein each of the plurality of columns add up in length to the standard column length.

2. The chromatography column assembly of claim 1, further comprising at least two frits.

3. The chromatography column assembly of claim 2, wherein each of the at least two-frits includes a metal crown frit seal.

4. The chromatography column assembly of claim 2, further comprising a connector structure located between a first of the plurality of columns and a second of the plurality of columns.

5. The chromatography column assembly of claim 4, wherein the connector structure includes a channel extending between a first frit of the first of the plurality of columns and a second frit of the second of the plurality of columns, and wherein a first cone distributor is located proximate the first frit for distributing and/or collecting fluid between the channel and the first frit, and wherein a second cone distributor is located proximate the second frit for distributing and/or collecting fluid between the channel and the second frit.

6. The chromatography column assembly of claim 4, wherein the connector structure includes a single frit configured to act as a fluidic channel between the first of the plurality of columns and the second of the plurality of columns.

7. The chromatography column assembly of claim 4, wherein the connector includes channel extending between a first frit of the first of the plurality of columns and a screen of the second of the plurality of columns, wherein a cone distributor located proximate the first frit for distributing and/or collecting fluid between the channel and the first frit, and wherein a volume distributor is located proximate the screen.

8. The chromatography column assembly of claim 4, wherein the connector includes channel extending between a first screen of the first of the plurality of columns and a second screen of the second of the plurality of columns, wherein a first volume distributor is located proximate the first screen, and wherein a second volume distributor is located proximate the second screen.

9. The chromatography column assembly of claim 1, wherein each of the plurality of columns includes an inner diameter of 2.1 mm.

10. The chromatography column assembly of claim 1, wherein each of the plurality of columns is the same length.

11. A liquid chromatography system comprising:
a solvent delivery system configured to provide a flow of a mobile phase;
a sample delivery system configured to inject a volume of a sample into the mobile phase;
the chromatography column assembly of claim 1, wherein the chromatography column assembly is located downstream from the sample delivery system and the solvent delivery system; and
a detector located downstream from the chromatography column assembly.

12. The liquid chromatography system of claim 11, wherein the chromatography column assembly further includes at least two frits.

13. The liquid chromatography system of claim 12, wherein each of the at least two frits includes a metal crown frit seal.

14. The liquid chromatography system of claim 12, wherein the chromatography column assembly further includes a connector structure located between a first of the plurality of columns and a second of the plurality of columns.

15. The liquid chromatography system of claim 14, wherein the connector structure includes a channel extending between a first frit of the first of the plurality of columns and a second frit of the second of the plurality of columns, and wherein a first cone distributor is located proximate the first frit for distributing and/or collecting fluid between the channel and the first frit, and wherein a second cone distributor is located proximate the second frit for distributing and/or collecting fluid between the channel and the second frit.

16. The liquid chromatography system of claim 14, wherein the connector structure includes a single frit configured to act as a fluidic channel between the first of the plurality of columns and the second of the plurality of columns.

17. The liquid chromatography system of claim 14, wherein the connector includes channel extending between a first frit of the first of the plurality of columns and a screen of the second of the plurality of columns, wherein a cone distributor located proximate the first frit for distributing and/or collecting fluid between the channel and the first frit, and wherein a volume distributor is located proximate the screen.

18. The liquid chromatography system of claim 14, wherein the connector includes channel extending between a first screen of the first of the plurality of columns and a second screen of the second of the plurality of columns, wherein a first volume distributor is located proximate the first screen, and wherein a second volume distributor is located proximate the second screen.

19. The liquid chromatography system of claim 11, wherein each of the plurality of columns includes an inner diameter of 2.1 mm.

20. The liquid chromatography system of claim 11, wherein each of the plurality of columns is the same length.

21. A chromatographic method comprising:
determining a chromatographic length for a separation process;
dividing the chromatographic length into a plurality of sub-parts;
assembling a chromatography column assembly that includes a plurality of columns connected in series, wherein each of the plurality of columns extends across one of the plurality of sub-parts such that the plurality of columns together equal the chromatographic length;
performing a separation process such that a sample sequentially moves through each of the plurality of columns connected in series; and
detecting the sample in a chromatograph down stream from the separation process.
